(19) United States
(12) Patent Application Publication
(10) Pub. No.: US 2023/0322576 A1
(43) Pub. Date: Oct. 12, 2023

(54) CHALCOGENIDE PEROVSKITES AND METHOD FOR SYNTHESIZING CHALCOGENIDE PEROVSKITES

(71) Applicant: Purdue Research Foundation, West Lafayette, IN (US)

(72) Inventors: Rakesh Agrawal, West Lafayette, IN (US); Apurva Ajit Pradhan, West Lafayette, IN (US); Jonathan William Turnley, Lafayette, IN (US); Suzanne C. Bart, West Lafayette, IN (US); Madeleine Claire Uible, Lafayette, IN (US)

(21) Appl. No.: 18/298,863

(22) Filed: Apr. 11, 2023

Related U.S. Application Data
(60) Provisional application No. 63/329,772, filed on Apr. 11, 2022.

(51) Int. Cl. C01G 25/06; C01G 27/06

(52) U.S. Cl. CPC C01G 25/06; C01G 27/06; C01P 2002/70; C01P 2002/82; C01P 2002/34

(57) ABSTRACT

Methods for synthesizing chalcogenide perovskites and chalcogenide perovskites synthesized thereby. Such s method includes providing a precursor solution containing a metal precursor, depositing the precursor solution onto a substrate to form a precursor film, and heating the precursor film in the presence of a chalcogen source to form a chalcogenide perovskite. The precursor solution is oxygen-free, and the steps of depositing and heating are conducted in an inert atmosphere.

### CROSS-REFERENCE TO RELATED APPLICATIONS

This application claims the benefit of U.S. Provisional Patent Application No. 63/329,772, filed Apr. 11, 2022, the contents of which are incorporated herein by reference.

### STATEMENT REGARDING FEDERALLY SPONSORED RESEARCH

This invention was made with government support under award numbers 1735282 and 1855882 awarded by the National Science Foundation. The government has certain rights in the invention.

### BACKGROUND OF THE INVENTION

The invention generally relates to chalcogenide perovskites and methods for synthesizing chalcogenide perovskites. More specifically, the invention relates to formation of a chalcogenide perovskite with a solution-based method.

Chalcogenide perovskites are a class of materials that have recently gained great interest for photovoltaic applications due to their high stabilities and excellent predicted optoelectronic properties, including a direct band gap, high near-band-edge absorption coefficients, and good carrier transport. However, device-compatible synthesis remains a challenge for chalcogenide perovskites. In the literature, materials in this class have been synthesized through solid-state reactions of binary sulfides or the sulfurization of oxide perovskites, and through vacuum-based deposition. However, both synthesis procedures often require temperatures greater than 800° C., making these procedures incompatible with the contact layers needed to complete a semiconductor device. Such high temperatures have been required due to slow interdiffusion of constituent metals in chalcogenide perovskites (primarily a combination of calcium, strontium, or barium with zirconium or hafnium) in the case of solid-state reactions, or due to the highly oxyphilic nature of constituent metals in the case of sulfurization of oxide films. While there are many approaches to create oxide perovskite films through solution-based deposition, high temperatures are still required to synthesize chalcogenide perovskites from oxide perovskite films. Although attempts have been made to apply direct solution-based deposition to chalcogenide perovskites, these have relied on simple metal precursors like metal halides and none have been successful to date.

In view of the above, there is an ongoing desire for methods that are capable of synthesizing chalcogenide perovskites without requiring the use of processing temperatures exceeding 800° C.

### BRIEF SUMMARY OF THE INVENTION

The intent of this section of the specification is to briefly indicate the nature and substance of the invention, as opposed to an exhaustive statement of all subject matter and aspects of the invention. Therefore, while this section [identifies/is intended to be directed to and consistent with] subject matter recited in the claims, additional subject matter and aspects relating to the invention are set forth in other sections of the specification, particularly the detailed description, as well as any drawings.

The present invention provides, but is not limited to, chalcogenide perovskites and methods for synthesizing chalcogenide perovskites, including a solution-based deposition approach for oxygen-free synthesis of chalcogenide perovskites.

According to one nonlimiting aspect, a method for synthesizing a chalcogenide perovskite includes providing a precursor solution containing a metal precursor wherein the precursor solution is oxygen-free, depositing the precursor solution onto a substrate to form a precursor film, and heating the precursor film in the presence of a chalcogen source to form a chalcogenide perovskite. The steps of depositing and heating are conducted in an inert atmosphere.

Technical aspects of methods as described above preferably include the ability to form chalcogenide perovskites at temperatures below 800° C., which in turn provides the capability of fabricating semiconductor devices that contain chalcogenide perovskites.

These and other aspects, arrangements, features, and/or technical effects will become apparent upon detailed inspection of the figures and the following description.

### BRIEF DESCRIPTION OF THE DRAWINGS

FIG. 1 represents steps in a method for synthesizing a chalcogenide perovskite utilizing solution-based, oxygen-free precursors in accordance with a nonlimiting aspect of the invention.

FIG. 2 is a graph showing the Powder X-Ray Diffraction pattern for BaZrS₃ chalcogenide perovskite produced by reacting bi s(pentamethylcyclopentadienyl) barium (an organometallic), carbon disulfide, and tetrakis(dimethylamido)zirconium(IV) (a metal organic) in a solution of oleylamine, heating and then casting the resulting solution onto a glass substrate, and subsequently heating to 575° C. in an evacuated ampule containing sulfur.

FIG. 3 is a graph showing the Powder X-Ray Diffraction pattern for BaZrS₃ produced by casting an ink containing bis(pentamethylcyclopentadienyl) barium, carbon disulfide, and tetrakis(dimethylamido)zirconium(IV) onto a glass substrate and subsequently heating to 575° C. in an evacuated ampule containing sulfur.

FIG. 4 is a graph showing the Powder X-Ray Diffraction pattern for BaZrS₃ produced by casting an ink containing bis(pentamethylcyclopentadienyl) barium, carbon disulfide, and tetrakis(diethylamido)zirconium(IV) onto a glass substrate and subsequently heating to 575° C. in an evacuated ampule containing sulfur.

FIG. 5 is a graph showing the Powder X-Ray Diffraction pattern for BaZrS₃ produced by casting an ink containing bis(pentamethylcyclopentadienyl) barium, carbon disulfide, and tetrakis(ethylmethylamido)zirconium(IV) onto a glass substrate and subsequently heating to 575° C. in an evacuated ampule containing sulfur and HfH₂ (hafnium hydride) nanoparticles as an oxygen trap.

FIG. 6 is a graph showing the Powder X-Ray Diffraction pattern for BaZrS₃ produced by casting an ink containing bis(pentamethylcyclopentadienyl) barium, carbon disulfide, and tetrabenzylzirconium (an organometallic) onto a glass substrate and subsequently heating to 575° C. in an evacuated ampule containing sulfur.

FIG. 7 is a graph showing the Powder X-Ray Diffraction pattern for BaZrS₃ produced by casting an ink containing bis(pentamethylcyclopentadienyl) barium, 2-methyl-2-propanethiol, and zirconium hydride nanoparticles onto a glass substrate and subsequently heating to 575° C. in an evacuated ampule containing sulfur.

FIG. 8 is a graph showing the Powder X-Ray Diffraction pattern for Ba₃Zr₂S₇ produced by casting an ink containing tetrabenzylzirconium, carbon disulfide, and a stoichiometric excess of bis(pentamethylcyclopentadienyl) barium onto a glass substrate and subsequently heating to 575° C. in an evacuated ampule containing sulfur.

FIG. 9 is a graph showing the Raman spectrum for Ba₃Zr₂S₇ produced by casting an ink containing tetrabenzylzirconium, carbon disulfide, and a stoichiometric excess of bis(pentamethylcyclopentadienyl) barium onto a glass substrate and subsequently heating to 575° C. in an evacuated ampule containing sulfur. This graph also demonstrates a match with the Raman spectrum acquired by Niu et. al. for Ba₃Zr₂S₇ produced by a solid-state approach.

FIG. 10 is a graph showing the Powder X-Ray Diffraction pattern for BaHfS₃ produced by casting an ink containing bis(pentamethylcyclopentadienyl) barium, carbon disulfide, and tetrakis(ethylmethylamido)hafnium(IV) (a metal organic) onto a glass substrate and subsequently heating to 575° C. in an evacuated ampule containing sulfur and HfH₂ nanoparticles as an oxygen trap.

FIG. 11 is a graph showing the Powder X-Ray Diffraction pattern for Ba₂HfS₄ produced by casting an ink containing bis(pentamethylcyclopentadienyl) barium, carbon disulfide, and tetrakis(dimethylamido)hafnium(IV) (a metal organic) onto a glass substrate and subsequently heating to 575° C. in an evacuated ampule containing sulfur.

FIG. 12 is a graph showing the Powder X-Ray Diffraction pattern for BaZrS₃ produced by casting an ink containing bis(pentamethylcyclopentadienyl) barium, ethyl isothiocyanate, and tetrakis(ethylmethylamido)zirconium(IV) onto a glass substrate and subsequently heating to 575° C. in an evacuated ampule containing sulfur and HfH₂ nanoparticles as an oxygen trap.

FIG. 13 is a graph showing the Powder X-Ray Diffraction pattern for BaZrS₃ produced by casting an ink containing bis(pentamethylcyclopentadienyl) barium, tetrakis(ethylmethylamido)zirconium(IV), and 2-methyl-2-propanethiol onto a molybdenum-coated glass substrate and subsequently heating to 575° C. in an evacuated ampule containing sulfur and ZrH₂ nanoparticles as an oxygen trap.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects described as part of a particular embodiment could be eliminated, and also encompasses additional or alternative embodiments that combine two or more features or aspects described as part of different embodiments. Therefore, the appended claims, and not the detailed description, are intended to particularly point out subject matter regarded to be aspects of the invention, including certain but not necessarily all of the aspects and alternatives described in the detailed description.

The following describes various aspects of methods capable of synthesizing chalcogenide perovskites utilizing a metal precursor-containing solution. As used herein, the term “chalcogenides” refers to sulfur and/or selenium anions. Examples of chalcogenide perovskites include, but are not limited to, BaZrS₃, BaHfS₃, CaZrS₃, SrZrS₃, CaHfS₃, SrHfS₃, BaZrSe₃, CaHfSe₃, CaZrSe₃, Ba₃Zr₂S₇, Ba₄Zr₃S₁₀, and Ba₂HfS₄. As described below, such methods preferably entail at least one constituent metal of a chalcogenide perovskite being delivered from a solution (liquid) phase containing the metal precursor(s), in which the metal precursor(s) do(es) not contain oxygen, i.e., preferred metal precursors are not oxygen-containing precursors. Once the metal precursor is supplied, heat treatment and the presence of the chalcogen produce a chalcogenide perovskite material.

Chalcogenide perovskites are a family of materials that are defined by their corner-sharing octahedra in the crystal structure. One common crystal structure for chalcogenide perovskites is the distorted perovskite structure, which as known in the art is a structure that generally takes the ABX₃ composition where A and B refer to the cations and X is the chalcogen anion (S²⁻ or Se²⁺ or a combination of the two). To maintain charge balance with the chalcogen anions, there are several combinations for the charges of the cations that are viable. This includes A²⁺ with B⁴⁺ (II-IV) and A³⁺ with B³⁺ (III-III). Potential examples of A²⁺ include but are not limited to Ba²⁺, sr²⁺, ca²⁺, pb²⁺, sn²⁺, and Eu²⁺. Potential examples of A³⁺ or B³⁺ include but are not limited to Y³⁺, Sc³⁺, and La³⁺. Potential examples of B⁴⁺ include but are not limited to Ti⁴⁺, Zr⁴⁺, Hf⁴⁺, Sn⁴⁺. A second form of chalcogenide perovskite is the layered Ruddlesden-Popper crystal structure which has the chemical composition Aₙ₊₁BₙX₃ₙ₊₁. These two-dimensional (2D) perovskite chalcogenides are formed by alternating a number (n) layers of ABX₃ perovskite with a layer of a rock salt AX. The cations in the ABX₃ layer may be different from the cations in the rock salt AX layer. To maintain charge balance in the Ruddlesden-Popper perovskites the A²⁺ and B⁴⁺ (II-IV) combination of cations is needed. In addition to the materials synthesized with a single element at the A, B, and X positions of the crystal structures, alloying at these sites can also be used to adjust the properties of the material. To date, the II-IV distorted chalcogenide perovskites have received significant attention, especially BaZrS₃. However, the methods exemplifying nonlimiting aspects of the present invention presented here are not intended to be limited to BaZrS₃ only and could be applied to other chalcogenide perovskites by changing the organometallic, metal organic, or nanoparticulate precursors to include the respective cations and anions or by changing the relative ratios of the precursors that are used.

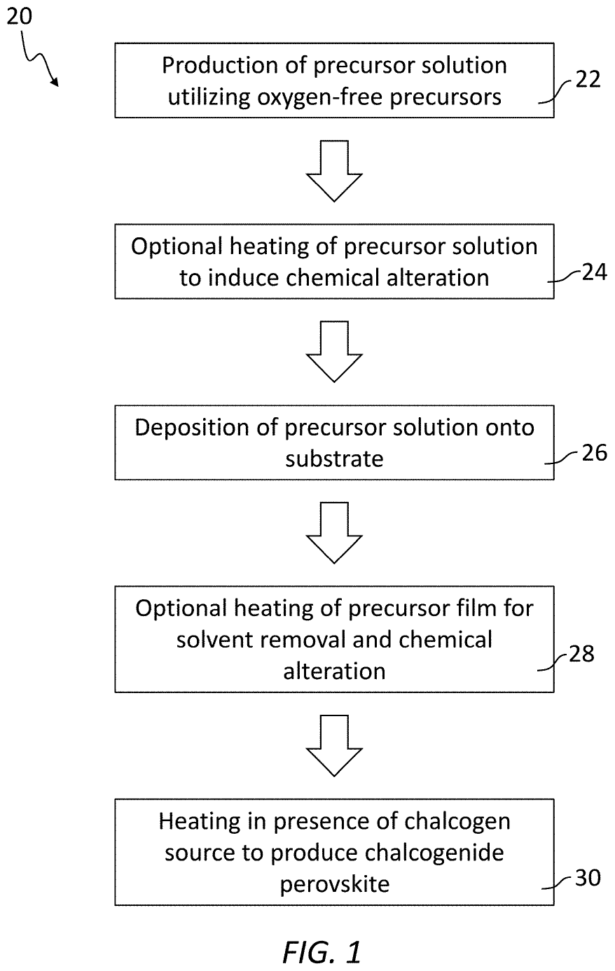

FIG. 1 illustrates a method 20 for synthesizing a chalcogenide perovskite according to a nonlimiting example of the present invention. At a first step 22, a precursor solution containing metal precursors for the desired chalcogenide perovskites is produced. The metal precursor(s) are mixed into a solution, preferably a liquid solution, which may include a solvent, such as carbon disulfide, to form the precursor solution. The metal precursors may have the form of any one or more of organometallics, metal organics, or metal-containing nanoparticles. An optional chalcogen source (e.g., sulfur or selenium) can be added to the precursor solution. This chalcogen source can come from a variety of sources including, but not limited to, CS₂, CSe₂, isothiocyanates, isoselenocyanates, thiolates, selenolates, thioureides, selenoureides, dichalcogenocarbamates, and dichalcogenocarboxylates. Furthermore, as an extension of the specific examples described hereinafter, the structure of the metal organic or organometallic precursors or the organic chalcogen sources can be altered with modified structures. The metal precursors are not oxygenated and the precursor solution is oxygen-free, which typically is realized by conducting the forming processes in step 22 in an inert atmosphere (e.g., without sufficient oxygen to allow significant oxidation of the precursor solution and/or its individual constituents) to prevent oxygenation of any of the constituents in the precursor solution. The precursor solution may be in an easily cast form, such as in a liquid form or semi-liquid (e.g., a paste) form, for ease of later deposition, although it is foreseeable that the precursor solution could be in other forms. The step 22 of forming the precursor solution may be omitted if, for example, the precursor solution is already available from another source.

Once the precursor solution is obtained, at a step 24 the precursor solution optionally may be heated to induce one or more chemical changes in the precursor metals and/or the precursor solution. However, this heating step 24 may be omitted in some embodiments.

Next at a step 26, the precursor solution is used to deliver the precursors to a substrate. Depositing the precursor solution onto the substrate forms a precursor film on the substrate. The precursor solution may be deposited onto the substrate in any suitable manner to form the precursor film, some non-limiting examples of which include casting, blade-coating, and drop-casting. However, other methods of depositing the liquid precursor solution onto the substrate to form the precursor film may also be used. As with the formation of the precursor solution, the deposition in step 26 is typically performed in an inert (substantially oxygen-free) atmosphere to prevent oxygenation of the precursor solution and/or the precursor film.

At a step 28, an optional heat treatment can then be performed on the precursor film to remove solvent and/or alter the chemical composition. For example, the optional heat treatment may be used to at least partially anneal and/or solidify the precursor film on the substrate, if for example the precursor solution was in a highly viscous, liquid state when applied to the substrate. The optional heat treatment may be performed temperatures much lower than 800° C. In some nonlimiting examples, the optional heat treatment may be performed at about 200° C. to about 500° C. The optional heat treatment may last a period of time sufficient to form the precursor film in a preferred state, typically only a few minutes. In some nonlimiting examples, the optional heat treatment may last from about one minute to about five minutes and/or about one to about five minutes per layer of precursor film (if, for example, multiple layers of precursor solution are deposited so as to form a corresponding multiple layers of precursor film). It is possible that the heat treatment at step 28 could be omitted, for example if the precursor film is already in a sufficiently solid state for further processing and/or of longer drying/solidifying times are acceptable.

At a step 30, the precursor film is heated in the presence of a chalcogen source for a period of time sufficient to convert at least some of the metal precursors into the chalcogenide perovskite material. The precursor film is typically (although not always necessarily) heated for at least ten minutes. In some nonlimiting examples, the precursor film is heated for about one hour to about forty-eight hours; however other time periods may be appropriate to obtain partial or complete conversion of the metal precursors into the chalcogenide perovskite material. The chalcogen source may include, but is not limited to, sulfur powder, selenium powder, CS₂, CSe₂, H₂S, and/or H₂Se. The step 30 may include a sulfurization process. All of the synthesis steps 22, 24, 26, 28, and 30 are conducted in an inert atmosphere.

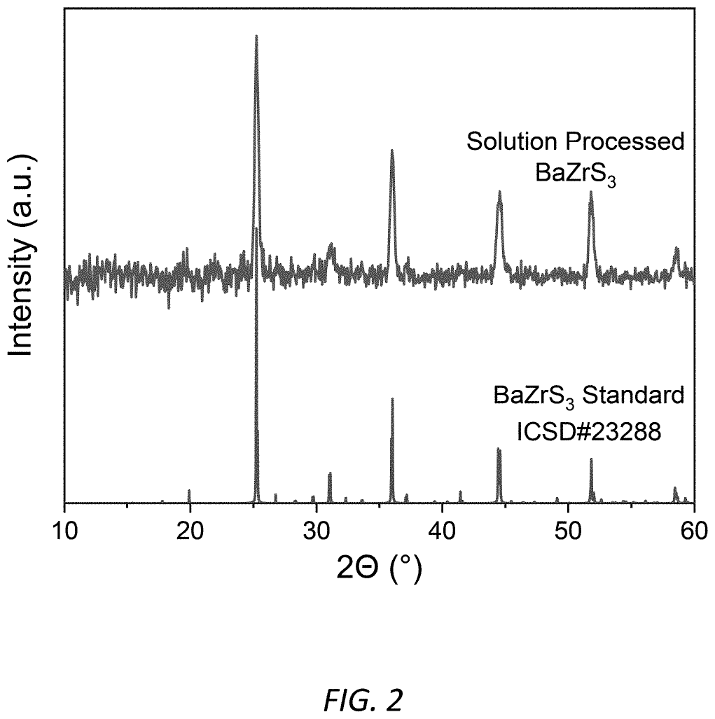

Example 1: A first nonlimiting experimental example of the method 20 began at step 22 in which organometallic bis(pentamethylcyclopentadienyl) barium and metal organic tetrakis(dimethylamido)zirconium(IV) were used as metal precursors in a carbon disulfide solution. A long-chain amine, such as oleylamine, was then added to the solution. At step 24, the solution was heated to 350° C. for 1 to 2 hours, thereby inducing a reaction that produces solids. The solids resulting from this reaction were washed by means of centrifugation using toluene as an antisolvent. The solids were then redispersed in a coating solvent, such as toluene, to create a precursor solution. At step 26, this precursor solution was then deposited on a glass substrate to form a precursor film and at step 28 heated in an inert atmosphere at temperatures of about 300° C. to about 400° C. Finally at step 30, a sulfurization process was employed by placing the sample produced in step 26 in an evacuated ampule containing excess elemental sulfur and heating it at 575° C. for twelve hours to produce the BaZrS₃ chalcogenide perovskite. FIG. 2 shows a powder X-ray diffraction pattern of a sample produced with this method, confirming the formation of crystalline BaZrS₃.

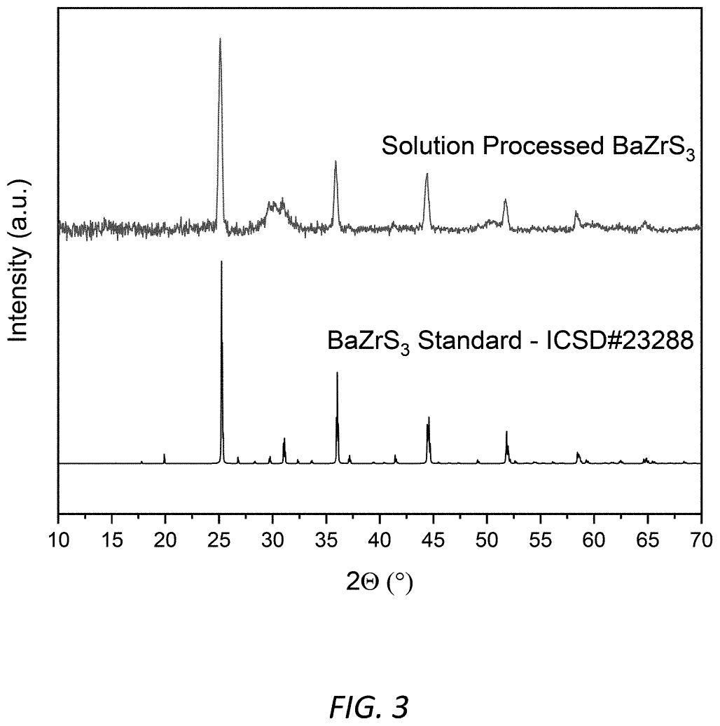

Example 2: A second nonlimiting example of the method 20 began by forming a precursor solution at step 22 by utilizing organometallic bis(pentamethylcyclopentadienyl) barium and metal organic tetrakis(dimethylamido)zirconium(IV) as metal precursors in a carbon disulfide solution. The suspension was stirred at ambient temperatures for at least 1 hour before being cast on a glass substrate to form a film at step 26 and annealed at 300° C. in an inert atmosphere for five minutes at step 28. Finally at step 30, the sulfurization process was employed by sealing the sample in an evacuated ampule containing excess elemental sulfur and heating it at 575° C. for at least ten minutes to produce the BaZrS₃ chalcogenide perovskite. FIG. 3 shows a powder X-ray diffraction pattern of a sample produced with this method with a one-hour sulfurization process, confirming the formation of crystalline BaZrS₃.

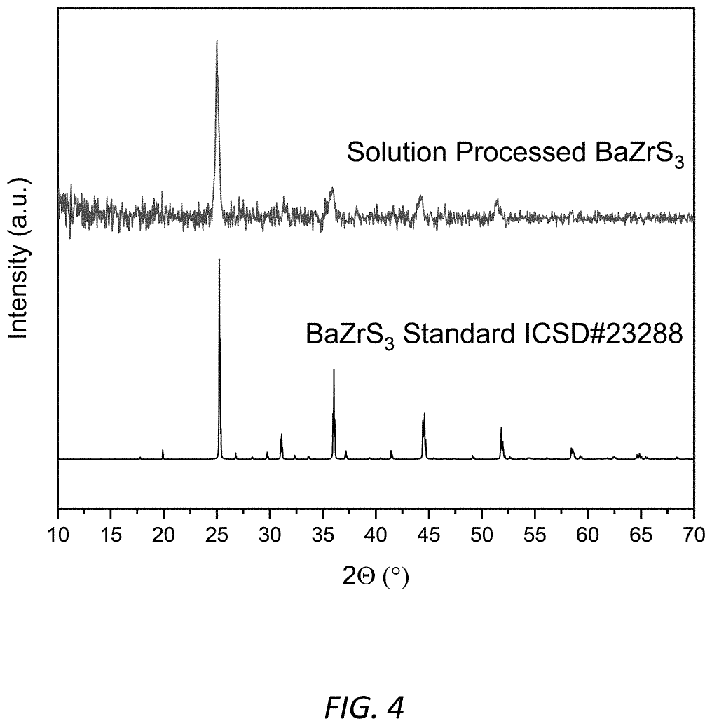

Example 3: A third nonlimiting example of the method 20 began by forming a precursor solution at step 22 by utilizing organometallic bis(pentamethylcyclopentadienyl) barium and metal organic tetrakis(diethylamido)zirconium(IV) as metal precursors in a carbon disulfide solution. At step 24, the solution was heated to 100° C. for 1 hour in a pressurized microwave reactor. At step 26, the resulting precursor solution was then cast onto a glass substrate and at step 28 heated to 300° C. in an inert atmosphere for five minutes. At step 30, the sulfurization process was employed by sealing the sample in an evacuated ampule containing excess elemental sulfur and heating the sample at 575° C. for at least ten minutes to produce the BaZrS₃ chalcogenide perovskite. FIG. 4 shows a powder X-ray diffraction pattern of a sample produced with this method with a forty-eight-hour sulfurization process, confirming the formation of crystalline BaZrS₃.

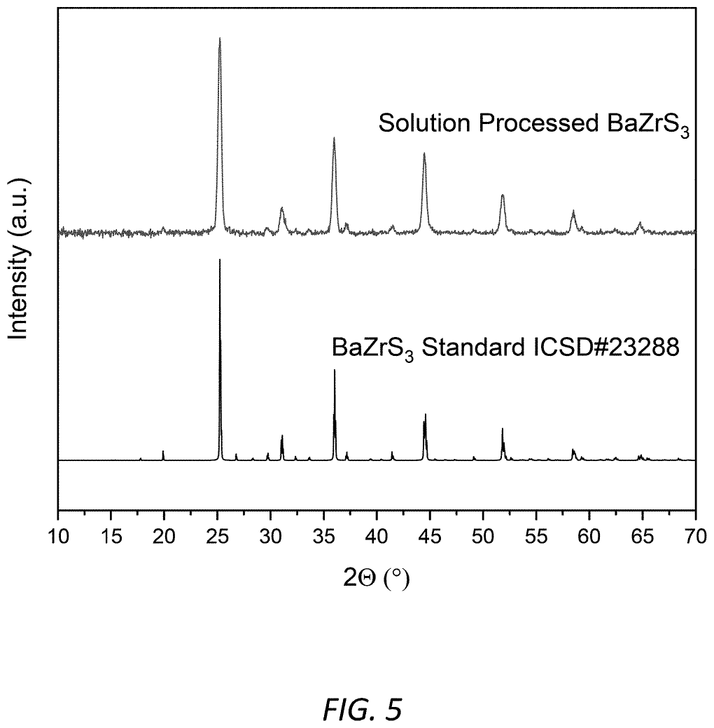

Example 4: A fourth nonlimiting example of the method 20 began by forming a precursor solution at step 22 by utilizing organometallic bis(pentamethylcyclopentadienyl) barium and metal organic tetrakis(ethylmethylamido)zirconium(IV) as metal precursors in a carbon disulfide solution. After stirring for at least one hour, excess CS₂ was removed in-vacuo and the resulting solids were redissolved in pyridine to create a single-phase precursor solution. At step 26, the precursor solution was blade-coated onto a glass substrate, and at step 28 the sample was heated to 200° C. for 3 minutes per layer for a total of six layers to form a precursor film. The precursor film was then sealed in an evacuated ampule containing excess elemental sulfur and HfH₂ as an oxygen trap, and at step 30 the sulfurization process was employed by heating the ampule at 575° C. for at least ten minutes to produce the BaZrS₃ chalcogenide perovskite with the sulfurization process. FIG. 5 shows a powder X-ray diffraction pattern of a sample produced with this method with a sixteen-hour sulfurization process, confirming the formation of crystalline BaZrS₃.

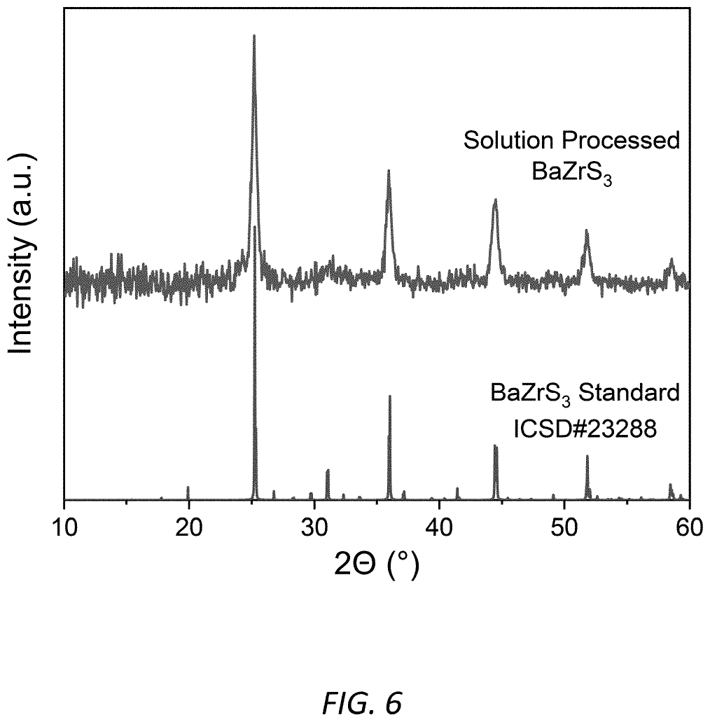

Example 5: A fifth nonlimiting example of the method 20 began by forming a precursor solution at step 22 by utilizing organometallic bis(pentamethylcyclopentadienyl) barium and organometallic tetrabenzylzirconium as metal precursors in a carbon disulfide solution and then stirring the precursor solution for at least one hour. At step 26, the precursor solution was then deposited on a glass substrate to form a precursor film, and at step 28, the sample was heated in an inert atmosphere at temperatures of about 300° C. to about 400° C. Finally at step 30, the sulfurization process was employed by placing the sample in an evacuated ampule containing excess elemental sulfur and heating it at 575° C. for at least ten minutes to produce the BaZrS₃ chalcogenide perovskite. FIG. 6 shows a powder X-ray diffraction pattern of a sample produced with this method with a sixteen-hour sulfurization, confirming the formation of crystalline BaZrS₃.

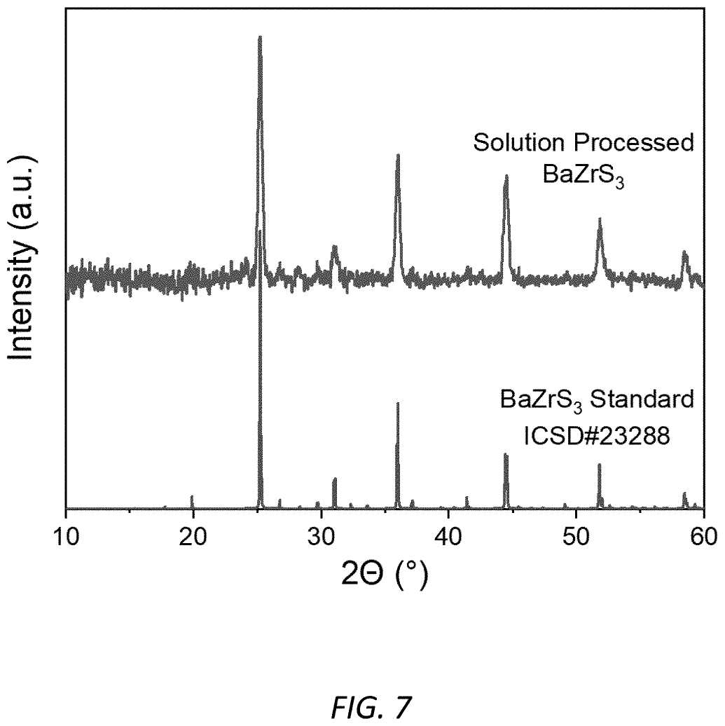

Example 6: A sixth nonlimiting example of the method 20 began by forming a precursor solution at step 22 by utilizing the organometallic bis(pentamethylcyclopentadienyl) barium and zirconium hydride nanoparticles as metal precursors in a butylamine solution. Additionally, 2-methyl-2-propanethiol was added to the ink (precursor solution) as a sulfur source. At step 26, the precursor solution was then deposited on a glass substrate to form a precursor film, and at step 28 the sample was heated in an inert atmosphere at temperatures of about 300° C. to about 420° C. Finally at step 30, the sulfurization process was employed by placing the sample in an evacuated ampule containing excess elemental sulfur and heating it at 575° C. for at least ten minutes to produce the BaZrS₃ chalcogenide perovskite. FIG. 7 shows a powder X-ray diffraction pattern of a sample produced with this method, confirming the formation of crystalline BaZrS₃.

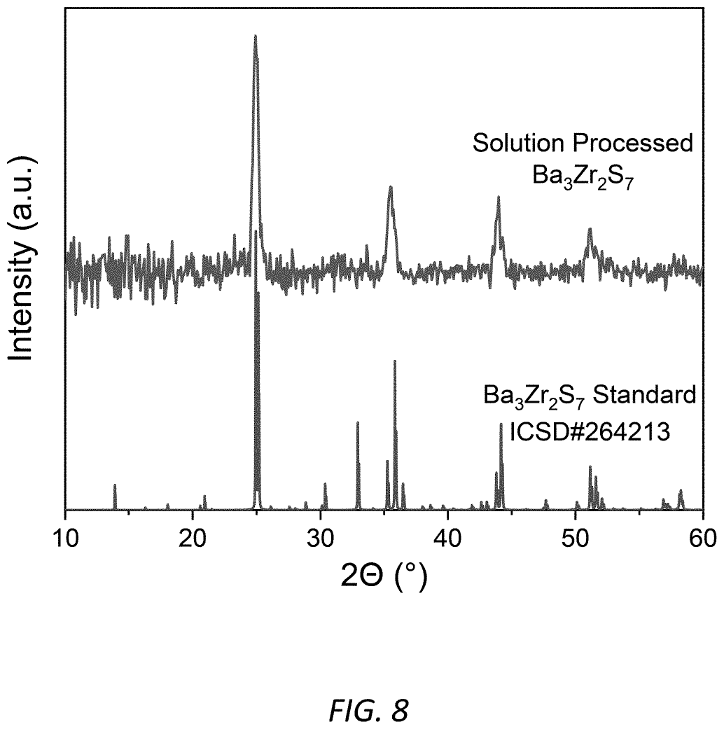

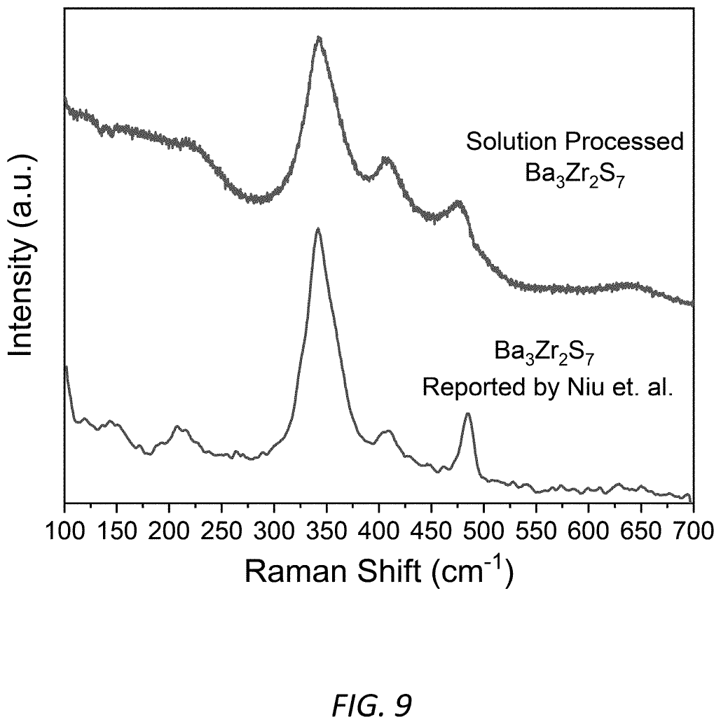

Example 7: A seventh nonlimiting example demonstrated that the method 20 is extendable to the Ruddlesden-Popper perovskite phase. At step 22, a precursor solution was formed by mixing organometallic tetrabenzylzirconium and a stochiometric excess (2 Ba: 1 Zr) of organometallic bis(pentamethylcyclopentadienyl) barium, which were used as metal precursors, in a carbon disulfide solution. At step 26, this precursor solution was then deposited on a glass substrate to form a precursor film, and at step 28, the resulting sample was heated in an inert atmosphere at temperatures of about 300° C. to about 400° C. Finally at step 30, the sulfurization process was employed by heating the sample at 575° C. in an ampule containing sulfur to produce the Ba₃Zr₂S₇ Ruddlesden-Popper perovskite phase. FIG. 8 shows a powder X-ray diffraction pattern of a sample produced with this method, confirming the formation of crystalline Ba₃Zr₂S₇. FIG. 9 shows a Raman spectrum of the Ba₃Zr₂S₇ Ruddlesden-Popper perovskite phase synthesized with this method in comparison to the Raman spectrum of the Ba₃Zr₂S₇ Ruddlesden-Popper perovskite phase synthesized using a conventional solid-state reaction approach at temperatures of 1100° C. The data illustrated in FIG. 9 provide further evidence of the successful formation of Ba₃Zr₂S₇ using the solution-based deposition method 20 of the present invention.

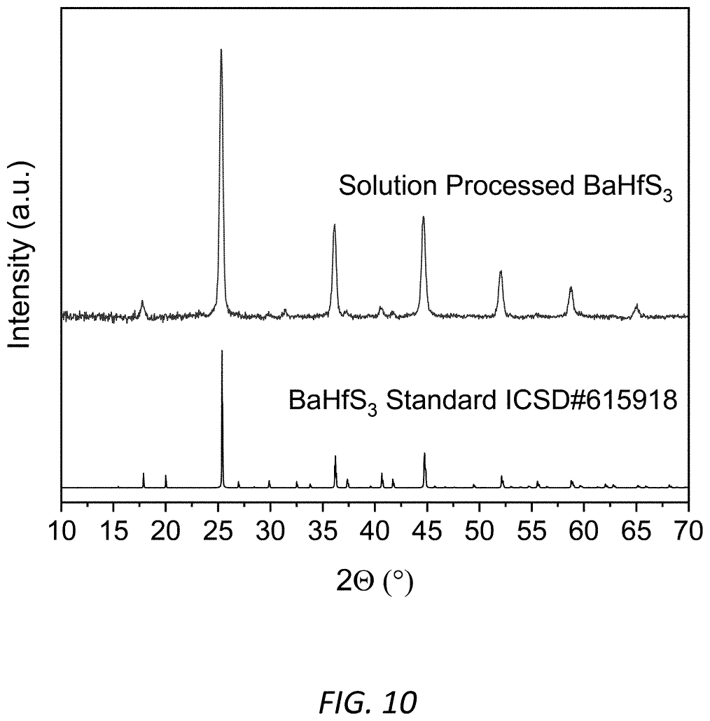

Example 8: An eighth nonlimiting example showed that the method 20 can be used to synthesize the perovskite phase of BaHfS₃. At step 22, a precursor solution was formed by mixing organometallic bis(pentamethylcyclopentadienyl) barium and metal organic tetrakis(ethylmethylamido)hafnium(IV), which were utilized as metal precursors, in a carbon disulfide solution. After stirring for at least one hour, excess CS₂ was removed in-vacuo and the resulting solids were redissolved in pyridine to create a single-phase precursor solution. At step 26, the single-phase precursor solution was blade-coated onto a glass substrate, and at step 28, the resulting sample was heated to 200° C. for three minutes per layer for a total of six layers to form a precursor film. The precursor film was then sealed in an evacuated ampule containing excess elemental sulfur and HfH₂ as an oxygen trap, and at step 30 the sulfurization process was employed by heating the ampule at 575° C. for at least ten minutes to produce the BaHfS₃ chalcogenide perovskite. FIG. 10 shows a powder X-ray diffraction pattern of a sample produced with this method with a sixteen-hour sulfurization process, confirming the formation of crystalline BaHfS₃.

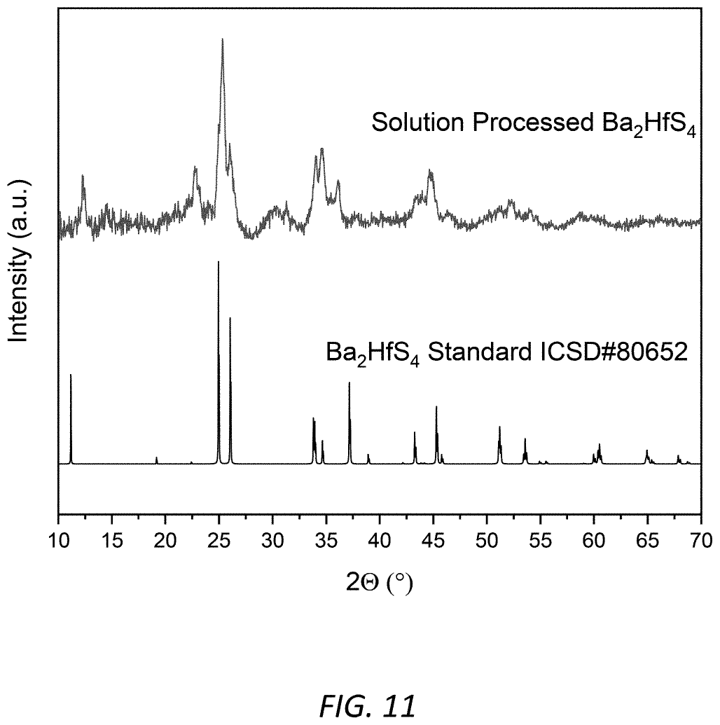

Example 9: A ninth nonlimiting example demonstrated that the method 20 can be used to synthesize the Ruddlesden-Popper phase, Ba₂HfS₄. At step 22, a precursor solution was formed by mixing organometallic bis(pentamethylcyclopentadienyl) barium and metal organic tetrakis(dimethylamido)hafnium(IV), which were utilized as metal precursors, in a carbon disulfide solution. After stirring for at least one hour, at step 26 the precursor solution was dropcast onto a glass substrate and at step 28 heated to 300° C. for five minutes to form a precursor film. The precursor film was then sealed in an evacuated ampule containing excess elemental sulfur, and at step 30 the sulfurization process was employed by heating the ampule at 575° C. for 24 hours to produce the Ba₂HfS₄ chalcogenide perovskite. FIG. 11 shows a powder X-ray diffraction pattern of a sample produced with this method with a twenty-four-hour sulfurization process, confirming the formation of crystalline Ba₂HfS₄.

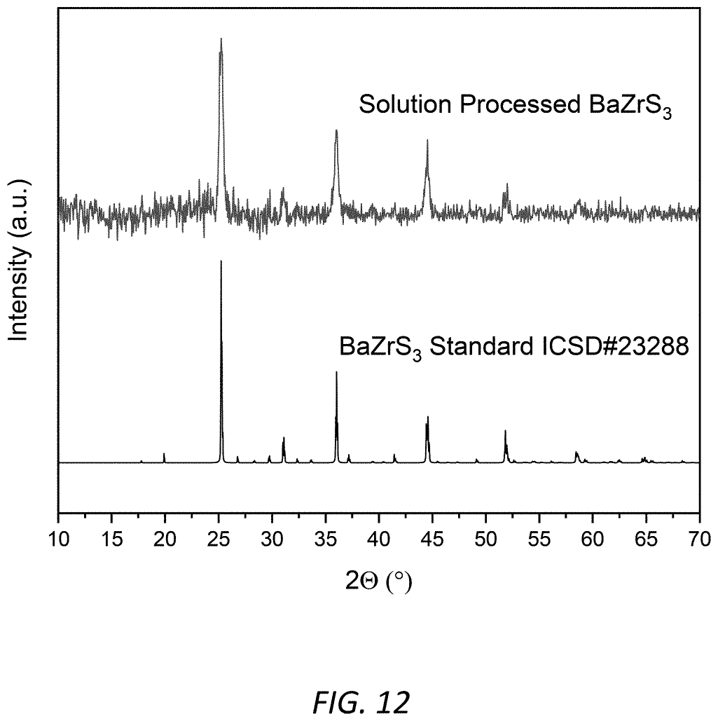

Example 10: A tenth nonlimiting example showed that, in addition to CS₂ and thiols, isothiocyanates can be utilized as chalcogen sources using the method 20 to synthesize chalcogenide perovskites. In this example, at step 22 BaZrS₃ was synthesized by combining organometallic bis(pentamethylcyclopentadienyl) barium and metal organic tetrakis(ethylmethylamido)zirconium(IV) as metal precursors with ethyl isothiocyanate in a pyridine solution to form a precursor solution. After stirring for at least 1 hour, at step 24 the precursor solution was cast onto a glass substrate and heated to 200° C. for three minutes to form a precursor film. The precursor film was then sealed in an evacuated ampule containing excess elemental sulfur and HfH₂ as an oxygen trap, and at step 30, the sulfurization process was employed by heating the ampule at 575° C. for one hour to produce the BaZrS₃ chalcogenide perovskite. FIG. 12 shows a powder X-ray diffraction pattern of a sample produced with this method with a one-hour sulfurization process, confirming the formation of crystalline BaZrS₃.

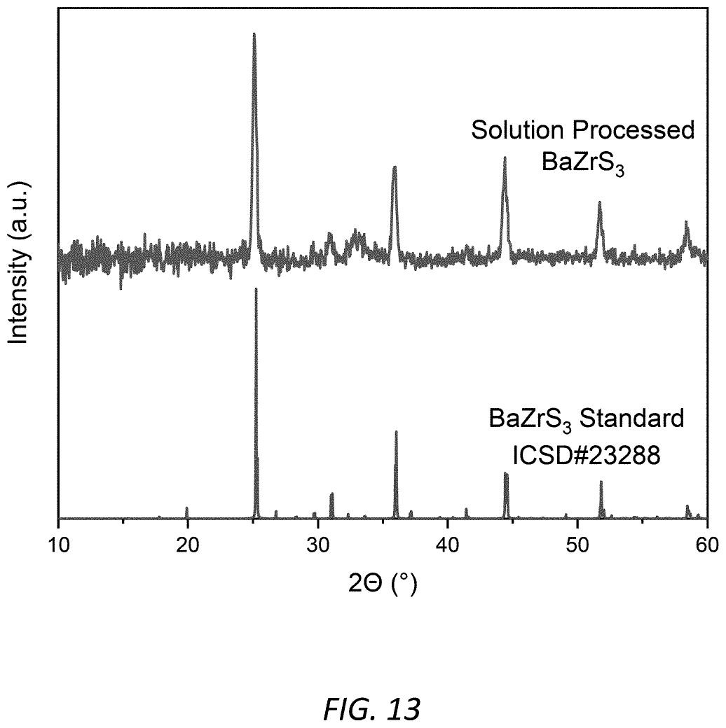

Example 11: An eleventh nonlimiting example of the method 20 began at step 22 by utilizing the organometallic bis(pentamethylcyclopentadienyl) barium and metal organic tetrakis(ethylmethylamido)zirconium(IV) as metal precursors in a butylamine solution to form a precursor solution. Additionally, 2-methyl-2-propanethiol was added to the ink as a sulfur source. At step 26, the precursor solution was then deposited on a molybdenum-coated glass substrate to form a precursor film, and at step 28 the sample was heated in an inert atmosphere at temperatures of about 300° C. to about 420° C. Finally, at step 30 the sulfurization process was employed by placing the precursor film in an evacuated ampule containing excess elemental sulfur and ZrH₂ as an oxygen trap and then heating the ampule at 575° C. for two hours to produce the BaZrS₃ chalcogenide perovskite. FIG. 13 shows a powder X-ray diffraction pattern of a sample produced with this method, confirming the formation of crystalline BaZrS₃.

In the course of conducting the above experiments, it was concluded that the method 20 cannot be used to synthesize chalcogenide perovskites if metal halides or metal oxides were utilized to supply the A and B cations. Furthermore, it was concluded that the method 20 will not be successful in creating chalcogenide perovskites if the solvent or the precursor solution is exposed to oxygen or water before the formation of crystalline chalcogenide perovskites at step 30.

From the examples described herein, it can be seen that in some nonlimiting examples, methods in accordance with the present invention generally include at least one of the constituent metals being delivered onto the substrate in the (liquid) solution phase. A chalcogenide perovskite may refer to the distorted perovskite or Ruddlesden-Popper perovskite crystal structures. Chalcogenide may refer to the inclusion of sulfide or selenide anions in the crystal structure of the chalcogenide perovskite. The sulfide or selenide anions may be supplied by CS₂, CSe₂, isothiocyanates, isoselenocyanates, thiolates, selenolates, thioureides, selenoureides, dichalcogenocarbamates, or dichalcogenocarboxylates. The metal precursor(s) are preferably free of oxygen and may take the form of an organometallic, a metal organic, and/or metal-containing nanoparticles. However, other configurations of the methods of the present invention are also contemplated.

As previously noted above, though the foregoing detailed description describes certain aspects of one or more particular embodiments of the invention, alternatives could be adopted by one skilled in the art. For example, functions of certain components of the methods could be performed by components of different construction but capable of a similar (though not necessarily equivalent) function, and various materials could be used in the implementation of the methods. As such, and again as was previously noted, it should be understood that the invention is not necessarily limited to any particular embodiment described herein or illustrated in the drawings.

1. A method of synthesizing a chalcogenide perovskite, the method comprising:
providing a precursor solution containing a metal precursor, wherein the precursor solution is oxygen-free;
depositing the precursor solution onto a substrate to form a precursor film; and
heating the precursor film in the presence of a chalcogen source to form a chalcogenide perovskite;
wherein the steps of depositing and heating are conducted in an inert atmosphere.

2. The method of claim 1, wherein the step of heating the precursor film comprises a sulfurization process.

3. The method of claim 2, wherein the sulfurization process comprises heating the precursor film at a temperature of less than 800° C. in an oxygen-free environment containing elemental sulfur for a period of time sufficient to form the chalcogenide perovskite.

4. The method of claim 1, wherein the chalcogenide perovskite comprises sulfide or selenide anions in a perovskite crystal structure.

5. The method of claim 4, wherein the chalcogen source comprises at least one of CS₂, CSe₂, isothiocyanates, isoselenocyanates, thiolates, selenolates, thioureides, selenoureides, dichalcogenocarbamates, and dichalcogenocarboxylates as a source of the sulfide or selenide anions.

6. The method of claim 1, wherein the chalcogenide perovskite has a distorted perovskite crystal structure.

7. The method of claim 1, wherein the chalcogenide perovskite has a Ruddlesden-Popper perovskite crystal structure.

8. The method of claim 1, wherein the metal precursor comprises an organometallic.

9. The method of claim 8, wherein the organometallic comprises at least one of bis(pentamethylcyclopentadienyl) barium and tetrabenzylzirconium.

10. The method of claim 1, wherein the metal precursor comprises a metal organic.

11. The method of claim 10, wherein the metal organic comprises tetrakis(dimethylamido)zirconium(IV).

12. The method of claim 1, wherein the metal precursor comprises metal-containing nanoparticles.

13. The method of claim 12, wherein the metal-containing nanoparticles comprise zirconium hydride.

14. The method of claim 1, wherein the metal precursor comprises at least one of an organometallic, a metal organic, and metal-containing nanoparticles.

15. The method of claim 1, wherein the step of providing a precursor solution comprises mixing the metal precursor with a liquid solution comprising a solvent in an inert atmosphere.

16. The method of claim 15, wherein the solvent comprises carbon disulfide.

17. The method of claim 1, further comprising heating the precursor solution to induce chemical alteration.

18. The method of claim 1, further comprising heating the precursor film to remove solvent therefrom.

19. The method of claim 1, wherein the chalcogen source comprises at least one of sulfur powder, selenium powder, CS₂, CSe₂, H₂S, and H₂Se.

20. A chalcogenide perovskite synthesized according to the method of claim 1.
